(19) United States
(12) Patent Application Publication
(10) Pub. No.: US 2015/0269444 A1
(43) Pub. Date: Sep. 24, 2015

(54) AUTOMATIC CLASSIFICATION SYSTEM FOR MOTOR VEHICLES

(71) Applicant: SURVISION, RUEIL MALMAISON (FR)

(72) Inventors: Bruno Lameyre, Soulaines-Sur-Aubance (FR); Jacques Jouannais, Paris (FR)

(21) Appl. No.: 14/667,577

(22) Filed: Mar. 24, 2015

(30) Foreign Application Priority Data
Mar. 24, 2014 (FR) 14 52453

(51) Int. Cl. G06K 9/00; G06K 9/62

(52) U.S. Cl. CPC G06K 9/00785; G06K 9/6268

(57) ABSTRACT

This automatic classification system according to the invention comprises a data processing unit (20) programmed to classify a vehicle present in the images captured by a camera (6), by processing the captured images, the captured images being intensity matrix images and the camera (6) being positioned capture images of the vehicle in birds-eye view and in three-quarters view, preferably three-quarters front view.

The present invention relates to the field of the automatic classification of motor vehicles, in particular to determine the amount of a toll to be paid.

Vehicles access to certain zones is sometimes subject to the payment of a toll, the amount of which often varies based on the class of vehicle, which is broken down into different classes based on predetermined criteria (length, number of axles, presence of a trailer, etc.).

It is possible to provide an automatic vehicle classification system to determine the amount of the toll to be paid by each vehicle.

FR 2,903,519 A1 discloses an automatic classification system for motor vehicles comprising a laser device combined with a thermal imaging camera to determine the class of the vehicles. The laser device makes it possible to measure the length, width and height of the vehicle. The thermal imaging camera makes it possible to estimate the number of rolling axles due to the heat they radiate.

EP 2,306,426 A1 discloses an automatic motor vehicle classification system comprising time-of-flight cameras capable of capturing a three-dimensional image of the scene to determine the physical characteristics of the vehicle and its class.

One aim of the present invention is to propose an automatic vehicle classification system that can be implemented simply and cost-effectively, while being reliable.

To that end, the invention proposes an automatic classification system for motor vehicles traveling on a road, comprising a data processing unit programmed to classify a vehicle present in the images captured by a camera, by processing the captured images, the captured images being intensity matrix images and the camera being positioned to capture images of the vehicle in birds-eye view and in three-quarters view, preferably three-quarters front view.

The classification system may optionally comprise one or more of the following features:
the data processing unit is programmed to compute a corrected image from the captured image, so as to reestablish, in the corrected image, the parallelism between parallel elements of the actual scene and the perpendicularity between perpendicular elements of the actual scene;
computing the corrected image produced therefrom by applying a predetermined transformation matrix to the captured image;
the data processing unit is programmed to compute a reconstituted image in which a vehicle is visible over its entire length, from a sequence of images in which at least one segment of the vehicle appears;
the data processing unit is programmed to identify characteristic points of the vehicle appearing in several images of the sequence of images, and to combine the images from the sequence of images based on the identified characteristic points to form the reconstituted image;
the data processing unit is programmed to compute the length and/or height of the vehicle from the reconstituted image;
the data processing unit is programmed to compute the number of axles of the vehicle by counting the number of wheels appearing on a side face of the vehicle visible from the reconstituted image;
the data processing unit is programmed to detect a wheel using an ellipse identification algorithm;
the data processing unit is programmed to count the number of axles based on the number of predetermined axle configurations;
the data processing unit is programmed to detect the entry of a new vehicle in the field of the camera by detecting a license plate in the captured images;
the data processing unit is programmed to detect the separation between a vehicle and the following vehicle based on photometric characteristics of the road and the road marking.

The invention also relates to an automatic classification system for vehicles comprising a camera providing intensity matrix images, the camera being positioned to capture images of the vehicles traveling on the road in birds-eye view and in three quarters view, preferably three quarters front view, and a data processing unit programmed for vehicle classification by processing the images captured by the camera.

The invention also relates to an automatic classification method for motor vehicles traveling on a road, comprising the classification of the vehicle present in the images captured by a camera, by processing images captured by a data processing unit, the captured images being intensity matrix images and the camera being positioned to capture images of the vehicle in birds-eye view and in three-quarters, preferably three-quarters front, view.

The invention also relates to a computer program product programmed to implement the above method, when it is executed by a data processing unit.

The invention and its advantages will be better understood upon reading the following description, provided solely as an example and done in reference to the appended drawings, in which:

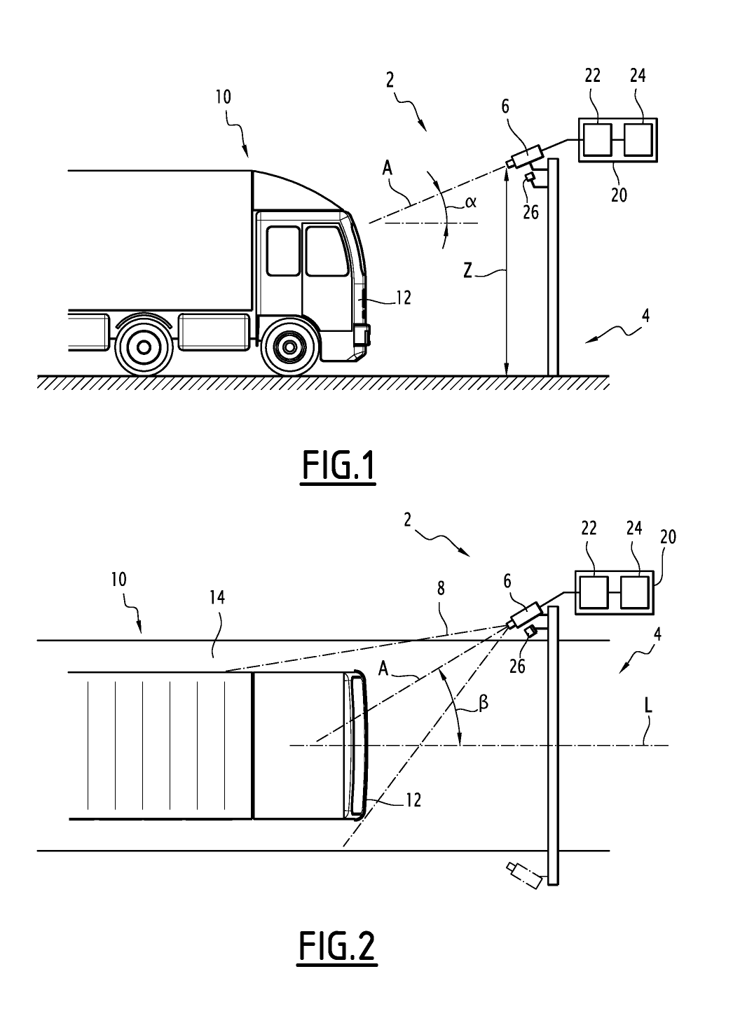

FIGS. 1 and 2 are diagrammatic side and top views of an automatic classification system;

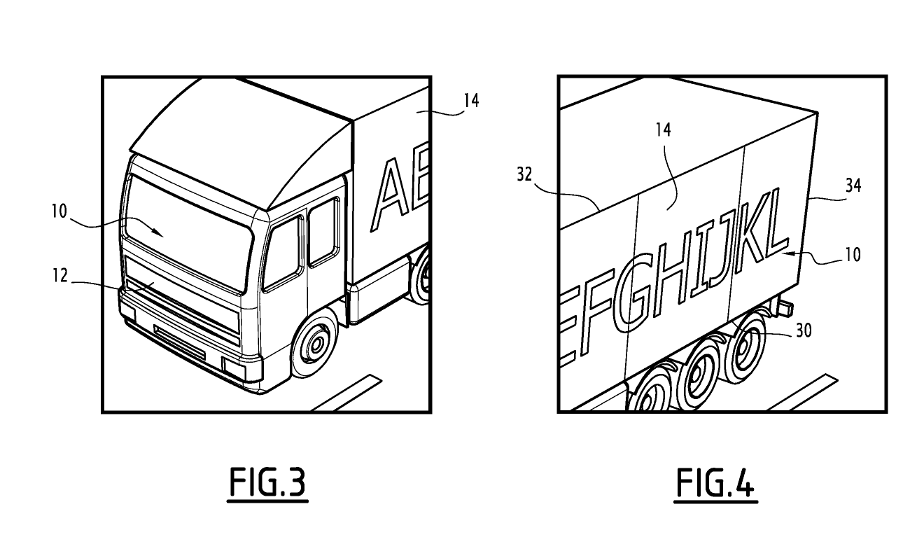

FIGS. 3 and 4 are illustrations of raw images captured by a camera of the automatic classification system, in which a vehicle appears;

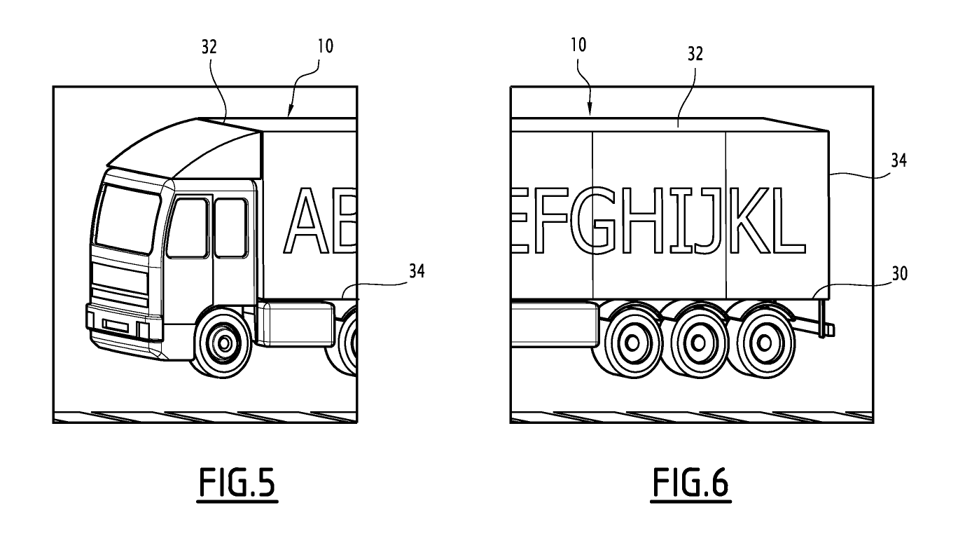

FIGS. 5 and 6 are illustrations of corrected images obtained by applying a geometric transformation of the raw images of FIGS. 3 and 4;

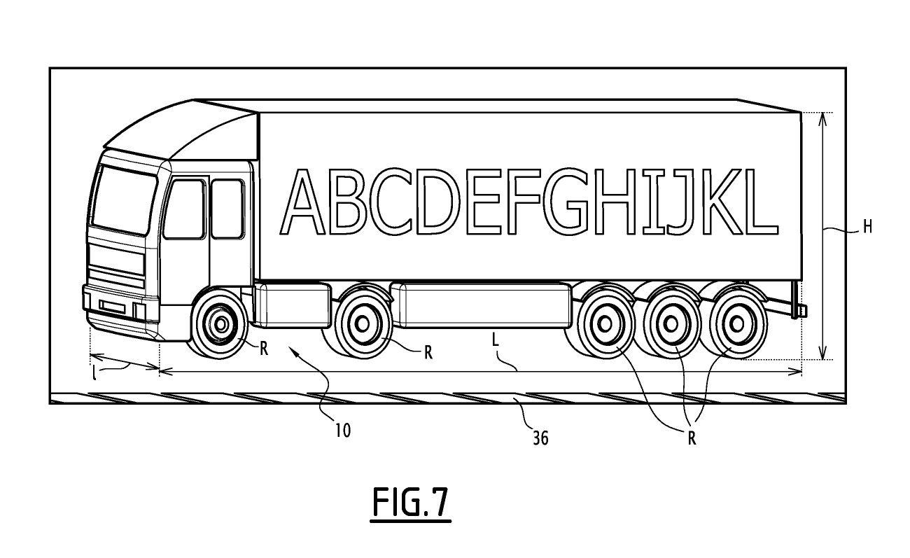

FIG. 7 is an illustration of a reconstituted image obtained by assembling corrected images, including the corrected images of FIGS. 5 and 6;

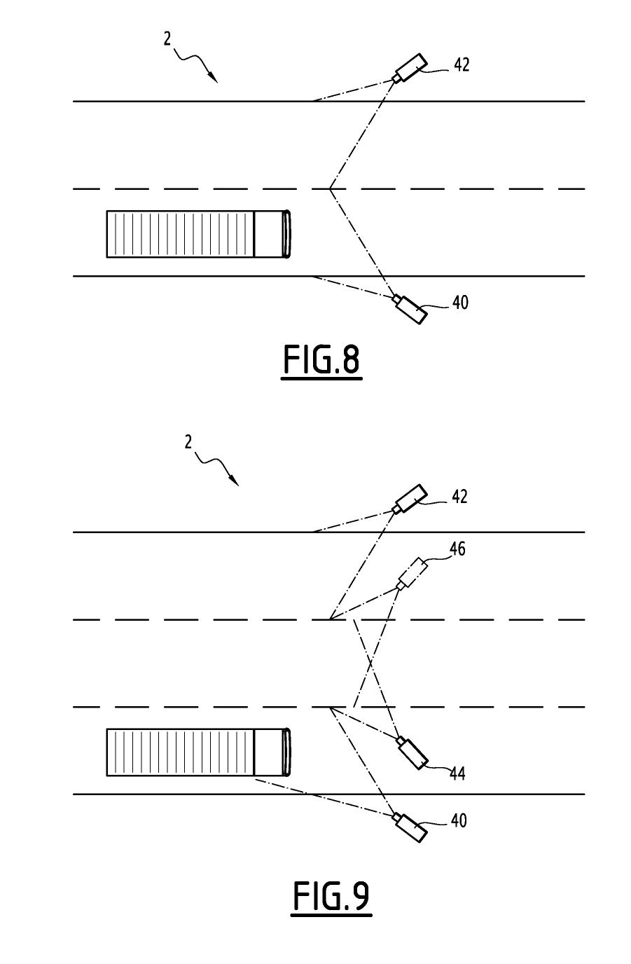

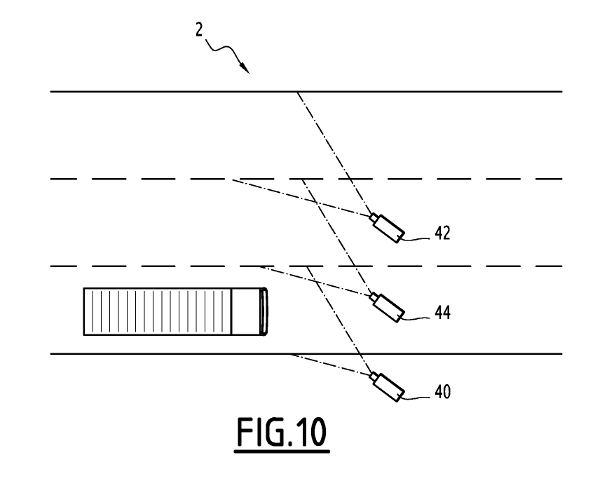

FIGS. 8, 9 and 10 are diagrammatic top views of an automatic classification system for multi-lane roads.

The classification system 2 of FIGS. 1 and 2 is arranged to classify vehicles traveling in a road lane automatically.

The classification system 2 comprises a camera 6 positioned on a support, here provided in the form of a gate straddling the road lane. Alternatively, in the event the number of lanes to be analyzed does not exceed two, a simple beam holding the camera is sufficient.

The camera 6 is a digital video camera supplying two-dimensional (2D) images of the scene present in the viewing field 8 of the camera 6.

The camera 6 has a digital photosensitive sensor, for example a CCD or CMOS sensor.

The camera 6 provides light intensity matrix images, in the spectral band of the visible frequencies. The camera 6 for example supplies the light intensity images in a spectral band comprised between 400 nanometers and 1 micrometer. Each image is made up of a matrix of pixels, each pixel being associated with a light intensity value.

The camera 6 is for example a black-and-white camera providing images whereof each pixel is associated with a single intensity value, corresponding to a gray level. Alternatively, the camera 6 is a color camera, each pixel being associated with several intensity values, each for a respective color.

The camera 6 is arranged so as to capture the vehicles 10 traveling on the road lane in birds-eye view and in three-quarters front view. The camera 6 is oriented such that the front face 12, then a side face 14 of the vehicle 10 traveling on the road lane 4 appear successively in the images captured by the camera 6.

The camera 6 is situated at a height relative to the vehicles. The viewing axis A of the camera 6 is oriented obliquely downward. The viewing axis A of the camera forms a nonzero angle with the horizontal plane and the vertical direction. The angle α between the viewing axis A and the horizontal plane is comprised between 20 and 35 degrees (FIG. 1). The camera is arranged at a height Z comprised between 5 meters and 7.5 meters relative to the level of the road lane.

The camera 6 is laterally offset relative to the central axis L of the road lane A. The viewing angle A of the camera is oblique relative to the central axis L of the road lane. Projected in a horizontal plane (FIG. 2), the viewing angle A of the camera 6 forms an angle β comprised between 10 and 25 degrees with the central axis L of the traffic lane 4.

The classification system 2 comprises a data processing unit 20 configured to classify vehicles automatically that appear in images taken by the camera 6, exclusively through digital processing of the images taken by the camera 6. Optionally, this processing unit may be incorporated into the camera 6.

The data processing unit 20 comprises a processor 22, a memory 24 and a software application stored in the memory 24 and executable by the processor 22. The software application comprises software instructions making it possible to determine the class of vehicles appearing in the images provided by the camera 6 exclusively through digital processing of the images taken by the camera 6.

The software application comprises one or more image processing algorithms making it possible to determine the class of vehicles appearing in the images supplied by the camera 6.

Optionally, the classification system 2 comprises a light projector 26 to illuminate the scene in the viewing field 8 of the camera 6. The light projector 26 for example emits a light in the nonvisible domain, in particular in infrared light, so as not to blind drivers. The light projector 26 for example emits a pulsed light, synchronized with the image capture by the camera 6, to limit the light emitted toward the vehicles. The camera 6 is sensitive to the light from the light projector 26.

FIGS. 3 and 4 illustrate raw images taken by the camera one after the other and in which a same vehicle 10 appears. The first raw image shows the front face 12 and a fraction of the side face 14 of the vehicle 10. The second raw image shows a fraction of the side face 14 of the vehicle 10.

The data processing unit 20 is programmed to implement a first step for correcting the raw images provided by the camera 6. Due to the orientation of the camera 6 relative to the traffic lane 4, a perspective effect is shown in the images. As a result, the geometric shapes of the objects present in the image are deformed relative to reality.

The correction step consists of applying a geometric transformation to each raw image in order to obtain a corrected image in which the parallelisms are reestablished between the parallel elements of the scene and the perpendicularity is reestablished between the perpendicular elements of the scene, in particular the parallelism between the parallel elements of the side face 14 of the vehicle 10 and the perpendicularity between the perpendicular elements of the side face 14 of the vehicle 10.

The same predetermined geometric transformation is applied to all of the images taken by the camera 6. The geometric transformation is determined beforehand, in a calibration phase of the classification system 2.

The correction step comprises applying a transformation matrix to the raw image, providing the corrected image as output. The transformation matrix is a predetermined matrix. The transformation matrix is determined in a calibration phase of the classification system 2.

FIGS. 5 and 6 illustrate the corrected images corresponding to the raw images of FIGS. 3 and 4, respectively.

As shown in FIGS. 5 and 6, the transformation used to correct the images from 6 is a homography, i.e., a projection of the projective space on itself. This transformation is given by a 3×3 transformation matrix comprising eight degrees of freedom.

In the image of FIG. 6, the parallelism, for example between the lower edge 30 and the upper edge 32 of the trailer of the vehicle 10, is reestablished, and the perpendicularity, for example the upper edge 32 and the rear edge 34 of the trailer of the vehicle 10, is reestablished.

The data processing unit 20 is programmed to carry out a second reconstitution step in which the images from a sequence of images, in each of which at least one fraction of the vehicle 10 appears, are assembled to obtain a reconstituted image in which the entire length of the vehicle appears. The reconstitution step here is done from a sequence of corrected images.

The data processing unit 20 is programmed to detect zones of interest in the images from the sequence of images. The data processing unit 24 is programmed to implement an algorithm for detecting points of interest.

The algorithm for detecting points of interest is for example a corner detection algorithm that detects the zones of the image where the intensity gradients vary quickly in several directions at once.

The data processing unit 24 is programmed to associate, with each of the points of interest, a characteristic value of the points so as to be able to determine the distance separating two points mathematically. The algorithm characterizing the point of interest is for example the first twenty harmonics of a direct cosinus transform (DCT) done on a zone of the image surrounding the point of interest.

The data processing unit 24 is programmed to form a reconstituted image by assembling the images from the sequence of images. This assembly is done by matching the points of interest detected in two successive images that have identical characteristics.

FIG. 7 is a reconstituted image of the vehicle obtained by assembling several images from a sequence of corrected images. Examples of points of interest used as reference points to assemble the images are circled in FIG. 7.

The data processing unit 20 is programmed to carry out a third step for measuring geometric characteristics of the vehicle from images taken by the camera. The measuring step is carried out in FIG. 7.

The measuring step comprises measuring the length L of the vehicle 10, the width I of the vehicle 10 and/or the height H of the vehicle 10. The correspondence between the actual dimensions of the vehicle and the dimensions of the vehicle in a reconstituted image is for example determined in a calibration step of the classification system. The dimensions of the vehicle in a reconstituted image are for example determined by a number of pixels.

The contours of the vehicle in the reconstituted image are for example determined using a contour detection algorithm.

The measuring step comprises measuring the transverse position of the vehicle on the traffic lane. The transverse direction is for example determined in reference to the signal of the traffic lane, in particular the ground markings of the traffic lane. Here, the transverse position is determined relative to a lateral marking strip 36 on the ground. The correspondence between the actual dimensions of the vehicle and the dimensions of the image of the vehicle in a reconstituted image, based on the lateral position of the vehicle, is for example determined in a calibration step of the classification system.

The measuring step comprises counting the number of axles of the vehicle. This measurement is done by detecting the wheels R on the side face 14 of the vehicle 10 visible in the images. The detection of the wheels R is done by detecting ellipses in the images taken by the camera, here in the reconstituted image (FIG. 7) obtained from images acquired by the camera. The data processing unit 24 is programmed to implement an ellipse recognition algorithm.

For example, the ellipse detection may be done by using a generalized Hough transform applied to the ellipses or by detecting one of the characteristic configurations of the distribution of the gradient direction.

It is possible for the data processing unit 20 to detect false positives, i.e., it detects an ellipse in the image whereas such an ellipse does not correspond to a wheel of the vehicle.

Optionally, counting the number of axles comprises comparing the position of the ellipses in the image with prerecorded reference configurations each corresponding to a possible axle configuration.

This comparison makes it possible to eliminate false positives in counting the number of axles of the vehicle, by detecting the correspondence between an ellipse group and a referenced configuration and eliminating an excess ellipse, considered to be a false positive.

The data processing unit 20 is programmed to determine the class of the vehicle appearing in images taken by the camera 6 based on measurements (measurements of geometric characteristics and/or counting the number of axles) done by the data processing unit 20.

The measuring unit is advantageously programmed to determine the class by comparing measurements (measurements of geometric characteristics and/or counting the number of axles) with a set of predetermined criteria.

The data processing unit 20 is programmed to detect each vehicle entering the field of vision 8 of the camera 6. The detection of each vehicle is done by detecting movements having coherent trajectories in the field of vision of the camera 6 and/or for example by detecting contours. The distinction between two vehicles following one another may be difficult if the two vehicles are too close together.

The data processing unit 20 is programmed to detect the separation between two close vehicles. During the day, this detection is based on the presence of symmetrical elements such as the grill and/or by detecting a license plate, optionally reading the license plate. At night, the detection of a separation between two close vehicles is based on the detection of the presence of headlights and the detection of a license plate, the latter being visible during the day and at night, since it reflects the infrared light emitted by the projector 26. The license plate detection is for example done by detecting the characteristic signature of the gradients of the image around the plate. The license plate is for example read using an optical character recognition algorithm. At night, headlight detection is done, for example, using an algorithm for detecting a significant variation of the brightness in images from the camera 6.

Alternatively or optionally, the detection of the presence of two close vehicles is done from a reference signaling element of the traffic lane, such as a marking on the ground or safety rails. These signaling elements, adjacent to the traffic lane, appear to be stationary elements of the sequences of images taken by the camera 6.

For example, the detection in the images of a sequence of images of different segments of a signaling element visible between two zones where the signaling element is hidden by the vehicle is a sign that the two zones correspond to close vehicles, the visible segment in each image corresponding to the interval between those two vehicles.

The reference signaling elements are detected in the images for example by template matching.

The signaling elements may nevertheless appear differently in the images based on the ambient conditions (brightness, daytime, nighttime, sun, rain, position of the sun, etc.) and the adjustment of the camera 6, which may be dynamic.

A detection of the signaling elements (e.g., template matching) operating for certain ambient conditions may not work properly for other ambient conditions.

Preferably, the data processing unit 20 is programmed to implement automatic and continuous learning of the photometric characteristics of the traffic lane and/or signaling elements.

The data processing unit 20 is a program to implement the detection of the separation of vehicles following one another, in particular from the traffic lane and/or the signaling elements, based on the photometric characteristics of the traffic lane and the signaling elements in the captured images.

For example, if signaling elements are detected by template matching, different templates are used on the one hand for photometric characteristics corresponding to a sunny morning, and on the other for photometric characteristics corresponding to the beginning of a cloudy evening.

During operation, the camera 6 takes images of the vehicles traveling in the traffic lane. The data processing image 20 detects vehicles 10 traveling in the traffic lane 4 in the images.

When the data processing unit 20 detect a vehicle 10, it records the sequence of raw images taken by the camera 6 and in which the vehicle 10 appears.

The data processing unit 20 carries out the correction step to correct the raw images and obtain the correct images by geometric transformation of the raw images.

The data processing unit 20 detects and characterizes the points of interest in the corrected image and assembles the corrected images based on points of interest, to form a reconstituted image in which the entire length of the vehicle 10 appears.

The data processing unit 20 measures geometric characteristics of the vehicle 20, in particular the length, width and height, and counts the number of wheels visible on the visible side face 14 of the vehicle 10.

The data processing unit 20 assigns a class to the vehicle based on the determined geometric characteristics.

Optionally, the data processing unit 20 records the sequence of images as proof of the passage of the vehicle, in case of any dispute. The recording is kept for a limited length of time, during which the dispute is possible.

In one embodiment, if the data processing unit 20 determines that it is not possible to classify the vehicle automatically with a sufficient confidence level, it sends the recording of the sequence of images out, for example for manual processing by an operator.

The position of the camera 6 and the orientation of its viewing axis A relative to the traffic lane to which the camera 6 is assigned may vary during installation of the classification system 2.

An installation method for the automatic motor vehicle classification system comprises a calibration phase done once the classification system is installed. The calibration step is performed before activation of the classification system or during use thereof.

The calibration phase comprises a measurement calibration step to calibrate the measurements provided by the data processing unit 20 based on the position of the camera 6.

The measurement calibration comprises taking images of a reference vehicle, with known dimensions, traveling in the traffic lane 4, and calibrating the measurements provided by the data processing unit 20 based on the known dimensions of the reference vehicle.

Alternatively or optionally, the measurement calibration comprises acquiring images of the traffic lane with no vehicle, measuring elements of the scene captured by the camera 6, and calibrating the measurements in a reconstituted image of the scene based on measurements done on the actual scene.

The calibration phase comprises a step for geometric transformation calibration, to determine the geometric transformation necessary to correct the raw images, i.e., to cancel the perspective effect.

The geometric transformation calibration is done by taking an image of a reference vehicle and graphically designating, for example using the mouse, four points on the reference vehicle forming a rectangle in the actual scene. The data processing unit 20 determines the geometric transformation based on parallel elements and perpendicular elements of the reference vehicle.

Alternatively or optionally, the geometric transformation calibration is done by taking an image of the scene in the viewing field of the camera without the vehicle and determining the geometric transformation based on parallel elements and/or perpendicular elements of the scene.

As shown in FIG. 2, the classification system 2 is configured to classify the vehicles traveling in a lane. The camera is positioned on the left of the lane (considering the direction of travel of vehicles in the lane) or the right (dotted lines in FIG. 2).

The classification system 2 of FIG. 7 is configured to classify the vehicles traveling on a two-lane road in which the vehicles travel in the same direction.

The classification system 2 comprises a respective camera 40, 42 assigned to each plane. The camera 40 for the right lane is positioned to the right of that right lane, while the camera 42 for the left lane is positioned to the left of the left lane. This prevents the camera assigned to one lane from being concealed by a vehicle traveling in the other lane.

The classification system of FIG. 8 is configured to classify the vehicles traveling on a road with at least three lanes (here exactly three lanes) in which the vehicles travel in the same direction.

The classification system comprises at least one respective camera assigned to each lane. A camera 40 assigned to the right lane is positioned to the right of that right lane. A camera 42 assigned to the left lane is positioned to the left of the left lane. A camera 44 assigned to a middle lane is positioned on the right of the middle lane (solid lines) or the left of the middle lane (dotted lines).

Optionally, the classification system 2 comprises two cameras 44, 46 assigned to a middle lane, one camera being positioned to the right of the middle lane and the other camera being positioned to the left the middle lane. The processing unit is programmed to use the images provided by either of the two cameras assigned to the same lane depending on whether the images from one camera or the other are usable, for example due to concealing of the lane by a vehicle traveling in another lane.

The classification system 2 of FIG. 9 differs from that of FIG. 8 in that a single camera is assigned to each lane, positioned to the left of the lane to which it is assigned, or alternatively to the right. This configuration of the cameras involves a concealing risk for all lanes except one.

Owing to the invention, the classification system 2 is simple and cost-effective to implement. In fact, the classification of vehicles traveling in a lane is done only by digital processing of intensity matrix images delivered by the camera. The sequences of images from that same camera may also be used as proof of the passage of the classified vehicle. It is not necessary to provide related devices such as magnetic loops, laser scanners or time-of-flight cameras, or thermal imaging cameras, which are expensive to install and use. The classification system 2 can be installed quickly and easily while minimizing the impact on traffic.

The digital processing applied to the raw images captured by the camera is simple and makes it possible to classify the vehicles reliably. The calibration phase next allows reliable implementation. The calibration phase is easy to perform.

1. An automatic classification system for motor vehicles traveling on a road, comprising a data processing unit programmed to classify a vehicle present in the images captured by a camera, by processing the captured images, the captured images being intensity matrix images and the camera being positioned capture images of the vehicle in birds-eye view and in three-quarters view.

2. The classification system according to claim 1, wherein the data processing unit is programmed to compute a corrected image from the captured image, so as to reestablish, in the corrected image, the parallelism between parallel elements of the actual scene and the perpendicularity between perpendicular elements of the actual scene.

3. The classification system according to claim 2, wherein computing the corrected image produced therefrom by applying a predetermined transformation matrix to the captured image.

4. The classification system according to claim 1, wherein the data processing unit is programmed to compute a reconstituted image in which a vehicle is visible over its entire length, from a sequence of images in which at least one segment of the vehicle appears.

5. The classification system according to claim 1, wherein the data processing unit is programmed to identify characteristic points of the vehicle appearing in several images of the sequence of images, and to combine the images from the sequence of images based on the identified characteristic points to form the reconstituted image.

6. The classification system according to claim 1, wherein the data processing unit is programmed to compute the length and/or height of the vehicle from the reconstituted image.

7. The classification system according to claim 1, wherein the data processing unit is programmed to compute the number of axles of the vehicle by counting the number of wheels appearing on a side face of the vehicle visible from the reconstituted image.

8. The classification system according to claim 7, wherein the data processing unit is programmed to detect a wheel using an ellipse identification algorithm.

9. The classification system according to claim 8, wherein the data processing unit is programmed to count the number of axles based on the number of predetermined axle configurations.

10. The classification system according to claim 1, wherein the data processing unit is programmed to detect the entry of a new vehicle in the field of the camera by detecting a license plate in the captured images.

11. The classification system according to claim 1, wherein the data processing unit is programmed to detect the separation between a vehicle and the following vehicle based on the road and/or the road marking.

12. The classification system according to claim 1, wherein the data processing unit is programmed to detect the separation between a vehicle and the following vehicle based on photometric characteristics of the road and/or the road marking.

13. The classification system according to claim 1, wherein the data processing unit is programmed to implement learning, of the photometric characteristics of the road and/or the road marking.

14. An automatic classification method for motor vehicles traveling on a road, comprising the classification of the vehicle present in the images captured by a camera, by processing images captured by a data processing unit, the captured images being intensity matrix images and the camera being positioned to capture images of the vehicle in birds-eye view and in three-quarters view.

15. A computer program product programmed to implement the method according to claim 14, when it is executed by a data processing unit.

16. The automatic classification system according to claim 1, wherein the camera is positioned to capture images of the vehicle in three-quarters front view.

17. The classification system according to claim 13, wherein the data processing unit is programmed to implement learning continuous of the photometric characteristics of the road and/or the road marking.

18. The automatic classification method for motor vehicles traveling on a road according to claim 14, wherein the camera is positioned to capture images of the vehicle in birds-eye view and in three-quarters front view.
